(19) United States
(12) Patent Application Publication
(10) Pub. No.: US 2005/0090140 A1
(43) Pub. Date: Apr. 28, 2005

(54) Connector assuring more reliable connection of a cable

(75) Inventors: Takeshi Shindo, Tokyo (JP); Keizo Kai, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Japan Aviation Electronics Industry, Limited, Tokyo (JP)

(21) Appl. No.: 10/970,072

(22) Filed: Oct. 21, 2004

(30) Foreign Application Priority Data
Oct. 23, 2003 (JP) 363171/2003

(51) Int. Cl. H01R 4/24

(52) U.S. Cl. 439/409

(57) ABSTRACT

In a connector to be connected to a cable by an insulation displacement connection, a first housing has a holding portion for receiving the cable. A second housing holds a contact and coupled to the first housing with its rotation with respect to the first housing. The contact is adapted to be contact with a mating connector and has a pair of insulation displacement portions faced to each other with a gap and adapted to be connected to the cable by the insulation displacement connection. The holding portion is inserted into the gap following the rotation of the second housing so that the cable is clamped between each of the insulation displacement portions and the holding portion.

This invention claims priority to prior Japanese patent application JP 2003-363171, the disclosure of which is incorporated herein by reference.

### BACKGROUND OF THE INVENTION

This invention relates to a connector to be connected to any kind of cables including a coaxial cable and a thin cable.

A connector of the type is disclosed, for example, in Japanese Patent Application Publication (JP-A) No. H11-345640. The connector comprises a housing, a plurality of contacts held by the housing, and a movable operating lever. The cables are positioned to face the contacts. Thereafter, when the operating lever is operated, the cables are pressed against the contacts by a pressing portion as a part of the operating lever. Thus, the connector is connected to the cables.

The connector of the type is also disclosed, for example, in Japanese Patent Application Publications (JP-A) Nos. H11-317248 and 2000-260497.

However, in each of the connectors mentioned above, reliability of connection is insufficient because the cables are merely pressed against the contacts by the pressing portion of the operating lever.

### SUMMARY OF THE INVENTION

It is therefore an object of the present invention to provide a connector capable of readily and reliably connecting a cable without increase of the number of parts by using a press-fitting technology which will herein be called an insulation displacement connection (IDC).

Other objects of the present invention will become clear as the description proceeds.

According to one aspect of the present invention, there is provided a connector to be connected to a cable by an insulation displacement connection, comprising a first housing having a holding portion for receiving the cable, a contact to be contacted with a mating connector, and a second housing holding the contact and coupled to the first housing with its rotation with respect to the first housing, the contact having a pair of insulation displacement portions faced to each other with a gap and adapted to be connected to the cable by the insulation displacement connection, the holding portion being inserted into the gap following the rotation of the second housing so that the cable is clamped between each of the insulation displacement portions and the holding portion.

Since the connector uses an insulation displacement connection technology, it will hereinafter be called an “insulation displacement connector”.

### BRIEF DESCRIPTION OF THE DRAWING

FIG. 1A is a sectional view of an insulation displacement connector according to a first embodiment of the present invention in the middle of an operation of attaching a plurality of coaxial cables to a first housing;

FIG. 1B is a sectional view similar to FIG. 1A after the coaxial cables are attached;

FIG. 2A is a sectional view showing an initial stage of a connecting operation of connecting the coaxial cables to the insulation displacement connector;

FIG. 2B is a sectional view similar to FIG. 2A in the middle of the connecting operation;

FIG. 3 is a sectional view similar to FIG. 2A after completion of the connecting operation;

FIG. 4 is a plan view of an insulation displacement connector according to a second embodiment of the present invention when a plurality of coaxial cables are attached to a first housing;

FIG. 4A is an enlarged sectional view taken along a line IVa-IVa in FIG. 4;

FIG. 4B is an enlarged sectional view taken along a line IVb-IVb in FIG. 4;

FIG. 4C is a side view of a ground bar used in FIG. 4B;

FIG. 5A is a sectional view showing an intermediate stage of a connecting operation of connecting the coaxial cables to the insulation displacement connector;

FIG. 5B is a sectional view similar to FIG. 5A after completion of the connecting operation;

FIG. 6A is a sectional view of an insulation displacement connector according to a third embodiment of the present invention in the middle of an operation of attaching a plurality of coaxial cables to a first housing;

FIG. 6B is a sectional view after the coaxial cables are attached;

FIG. 7A is a sectional view showing an intermediate stage of a connecting operation of connecting the coaxial cables to the insulation displacement connector;

FIG. 7B is a sectional view similar to FIG. 7A after completion of the connecting operation;

FIG. 8 is a sectional view similar to FIG. 7A after completion of the connecting operation;

FIG. 9 is a plan view of an insulation displacement connector according to a fourth embodiment of the present invention when a plurality of coaxial cables are attached to a first housing;

FIG. 9A is an enlarged sectional view taken along a line IXa-IXa in FIG. 9;

FIG. 9B is an enlarged sectional view taken along a line IXb-IXb in FIG. 9;

FIG. 10A is a sectional view showing an intermediate stage of a connecting operation of connecting the coaxial cables to the insulation displacement connector;

FIG. 10B is a sectional view similar to FIG. 10A after completion of the connecting operation;

FIG. 11 is a perspective view showing the state where coaxial cables are connected to a selected one of the insulation displacement connectors according to the first through the fourth embodiments of the present invention;

FIG. 12 is a front view of an example of a flat cable comprising a plurality of coaxial cables;

FIG. 13 is a perspective view of an insulation displacement connector according to a fifth embodiment of the present invention when a plurality of coaxial cables are connected thereto;

FIG. 14A is a sectional view showing an intermediate stage of a connecting operation of connecting the coaxial cables to the insulation displacement connector in FIG. 13;

FIG. 14B is an end view corresponding to FIG. 14A as seen in a direction depicted by an arrow XIV;

FIG. 15A is a sectional view after completion of the connecting operation; and

FIG. 15B is an end view corresponding to FIG. 15A as seen in a direction depicted by an arrow XV.

### DESCRIPTION OF THE PREFERRED EMBODIMENTS

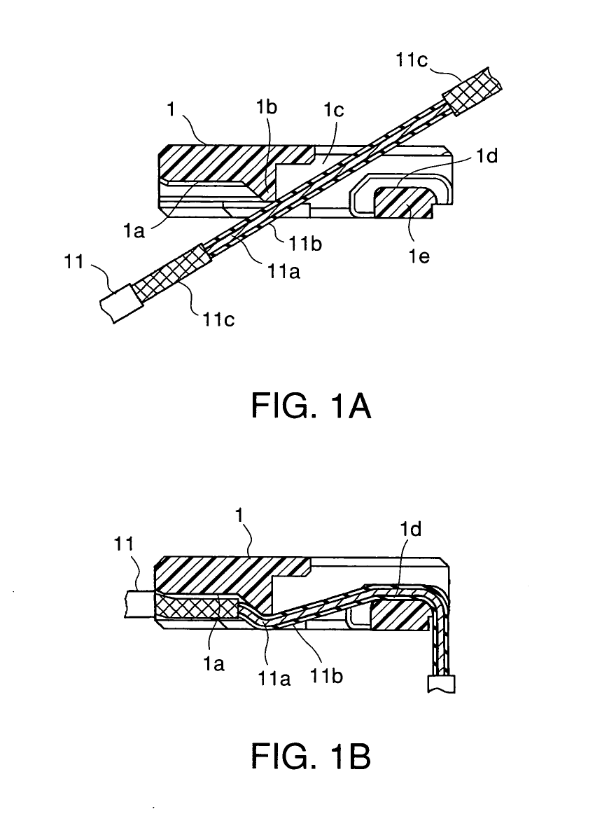

At first referring to FIGS. 1A, 1B, 2A, 2B, and 3, description will be made of an insulation displacement connector according to a first embodiment of the present invention.

Referring to FIG. 1A, the Insulation displacement connector comprises a first housing 1 made of synthetic resin. The first housing 1 is provided with a plurality of grooves 1a formed at a left lower half portion thereof to receive a plurality of coaxial cables 11, respectively, and a protruding guide portion 1b having a generally triangular shape. The grooves 1a are formed at a predetermined pitch in a predetermined direction, i.e., a direction perpendicular to a drawing sheet. The first housing 1 has, at a right half portion, a space 1c and a plurality of grooves 1d both for receiving the coaxial cables 11, and a protruding guide portion 1e having a generally rectangular shape and serving as a holding portion. Each of the coaxial cables 11 comprises a conductive core wire 11a coated with a dielectric member 11b and a grounding external conductor 11c successively formed around the core wire 11a. Prior to connection to the Insulation displacement connector, the external conductor 11c at an end of each coaxial cable 11 is peeled off and removed.

In the state illustrated in FIG. 1A, each of the coaxial cables 11 is press-fitted into the grooves 1b and 1d and arranged along the protruding guide portions 1b and 1e. Then, the state illustrated in FIG. 1B is reached. In this state, each coaxial cable 11 is applied with tension. Since the coaxial cable 11 is held in the groove 1d on the protruding guide portion 1e, the coaxial cable 11 is stable held in the first housing 1.

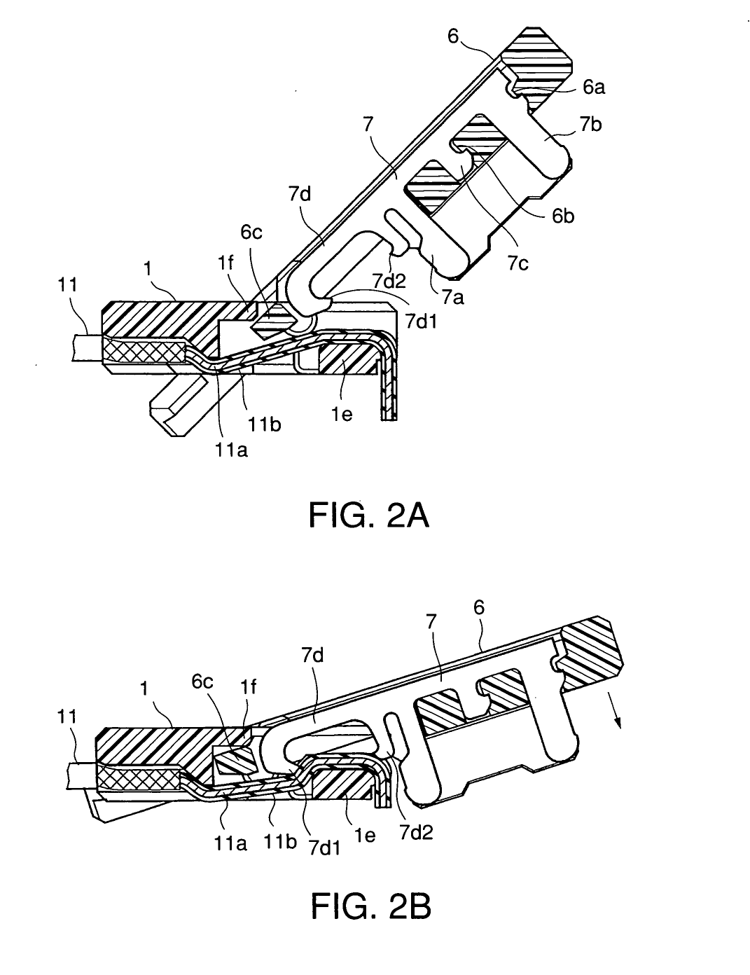

Referring to FIG. 2A, the Insulation displacement connector further comprises a second housing 6 made of synthetic resin and a plurality of conductive contacts 7 held by the second housing 6 and arranged at a predetermined pitch in the predetermined direction. The second housing 6 is provided with a plurality of press-fit grooves 6a and 6b formed at a predetermined pitch in a direction perpendicular to the drawing sheet to hold the contacts 7, and a pivot point portion 6c serving as a pivot point or center of rotation when the second housing 6 is rotated with respect to the first housing 1. Each contact 7 has a pair of connection terminal portions 7a and 7b, a fixing portion 7c, and a press-contacting terminal portion 7d. The press-contacting terminal portion 7d is provided with a pair of first and second blade shape portions 7d1 and 7d2 faced to each other with a gap. The first and the second blade shape portions 7d1 and 7d2 are referred to as press-contacting portions or insulation displacement contact portions, respectively. The connection terminal portion 7b and the fixing portion 7c of each contact 7 are press-fitted into the press-fit grooves 6a and 6b of the second housing 6, respectively.

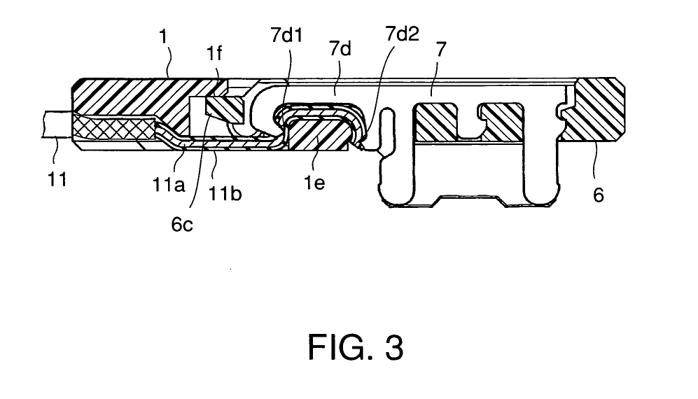

As illustrated in FIG. 2A, the second housing 6 is inserted into the first housing 1 in an inclined position. In this state, the second housing 6 is rotated clockwise around the pivot point portion 6c (herein, the pivot point portion 6c is slightly moved during rotation). Then, the pivot point portion 6c is butted against a protruding support portion 1f of the first housing 1 and the second housing 6 is rotatably moved through the state illustrated in FIG. 2B to the state illustrated in FIG. 3. Eventually, the protruding guide portion 1e is inserted into the gap between the first and the second blade shape portions 7d1 and 7d2 so that the cable 11 is clamped between each of the first and the second blade shape portions 7d1 and 7d2 and the protruding guide portion 1e.

Following the rotatable movement of the second housing 6, the first and the second blade shape portions 7d1 and 7d2 of each contact 7 break the dielectric member 11b of each coaxial cable 11 and penetrate through the dielectric member 11b to be press-contacted with the core wire 1a. Thus, each contact 7 is electrically connected to each coaxial cable 11 by using a press-fitting technology which is similar to an insulation displacement connection (IDC) known in the art and therefore will also be called herein an insulation displacement connection.

More particularly, the blade shape portions 7d1 and 7d2 easily break the dielectric member 11b of the coaxial cable 11 and clamp both of the protruding guide portion or holding portion 1e of the first housing 1 and the coaxial cable 11. Because mutual contact is established by the insulation displacement contact portions (7d1, 7d2), the contact 7 is reliably connected to the coaxial cable 11. Since the contact 7 is connected to the coaxial cable 11 at two positions, connection is more reliable. Thereafter, the connection terminal portions 7a and 7b of the Insulation displacement connector are connected to corresponding connection terminal portions of a mating connector (not shown).

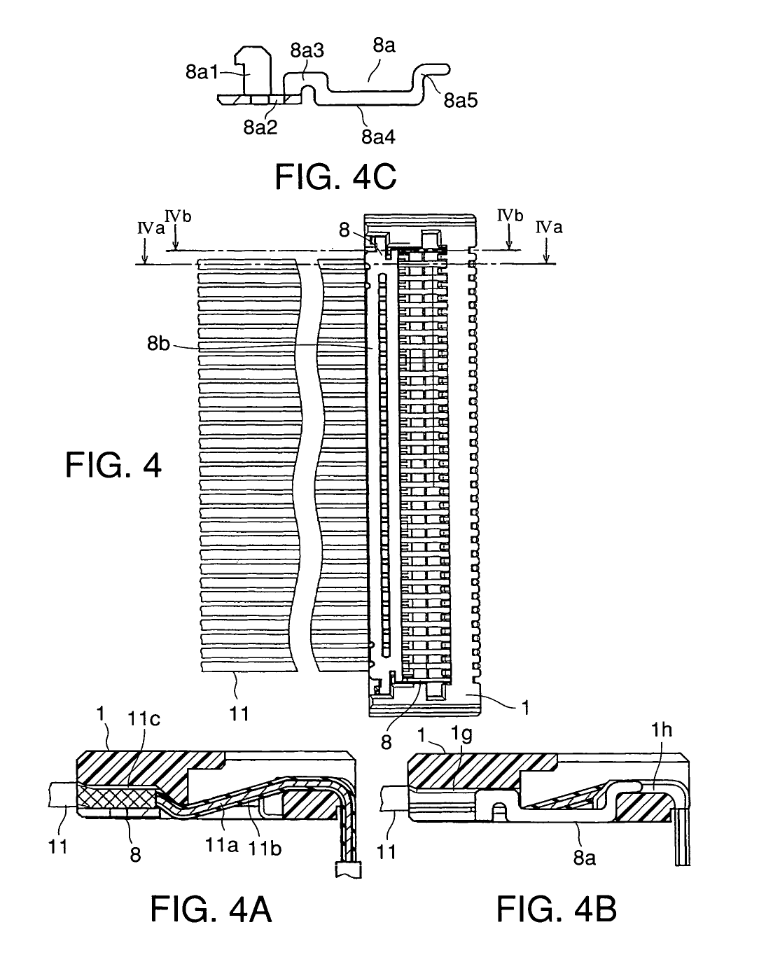

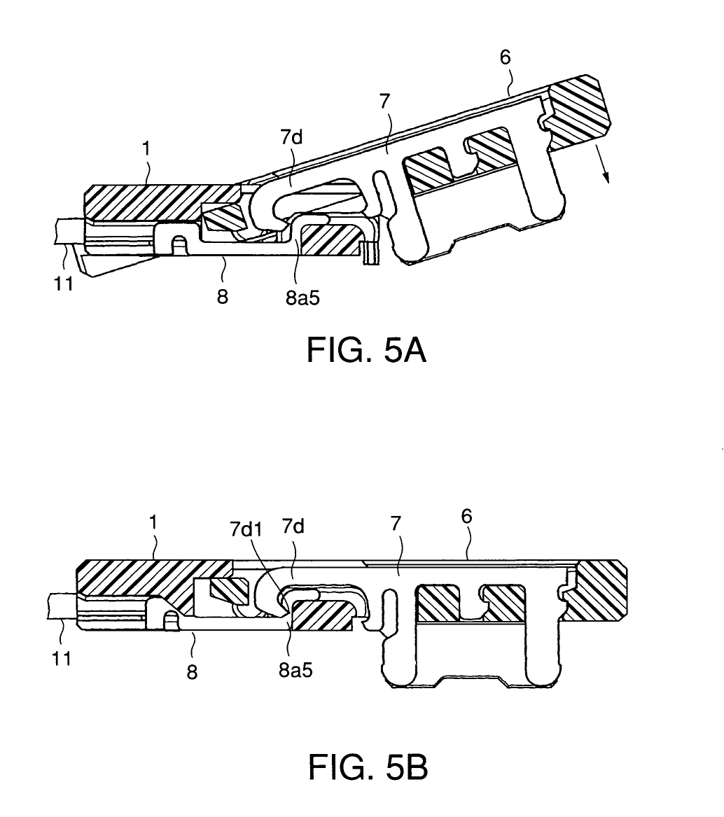

Next referring to FIGS. 4, 4A, 4B, 5A, and 5B, description will be made of an Insulation displacement connector according to a second embodiment of the present invention. Similar parts are designated by like reference numerals and description thereof will be omitted.

The Insulation displacement connector further comprises a conductive ground bar 8 held by the first housing 1. The ground bar 8 has a pair of side portions 8a and a coupling portion 8b in the shape of a rectangular frame coupling the side portions 8a to each other. Each of the side portions 8a has an integral structure including a press-fit portion 8a1, a first linear coupling portion 8a2, a U-shaped portion 8a3, and a second linear coupling portion 8a4, and a L-shaped portion 8a5.

The ground bar 8 is attached to the first housing 1 in the following manner. The press-fit portion 8a1 of each side portion 8a is press-fitted into each groove (not shown) formed on the first housing 1. At this time, the U-shaped portion 8a3 and the L-shaped portion 8a5 are inserted into grooves 1g and 1h formed on the first housing 1, respectively. Then, each side portion 8a is put into the state illustrated in FIG. 4B. As illustrated in FIG. 4, an upper surface of the coupling portion 8b of the ground bar 8 and the external conductor 11c of each coaxial cable 11 are soldered.

Thereafter, the second housing 6 is inserted into the first housing 1 in an inclined position as illustrated in FIG. 5A and is rotated with respect to the first housing 1 to the state illustrated in FIG. 5B. Then, the first blade shape portions 7d1 of the contacts 7 arranged at opposite ends in the predetermined direction bite into the L-shaped portion 8a5 of the ground bar 8. Thus, a ground structure is formed.

In each of the remaining contacts 7, the first and the second blade shape portions 7d1 and 7d2 break the dielectric member 11b of each coaxial cable 11 to be press-contacted with the core wire 11a, as illustrated in FIG. 2B. As a result, the blade shape portions 7d1 and 7d2 clamp both of the protruding guide portion 1e of the first housing 1 and the coaxial cable 11. Thus, each contact 7 is electrically connected to each coaxial cable 11.

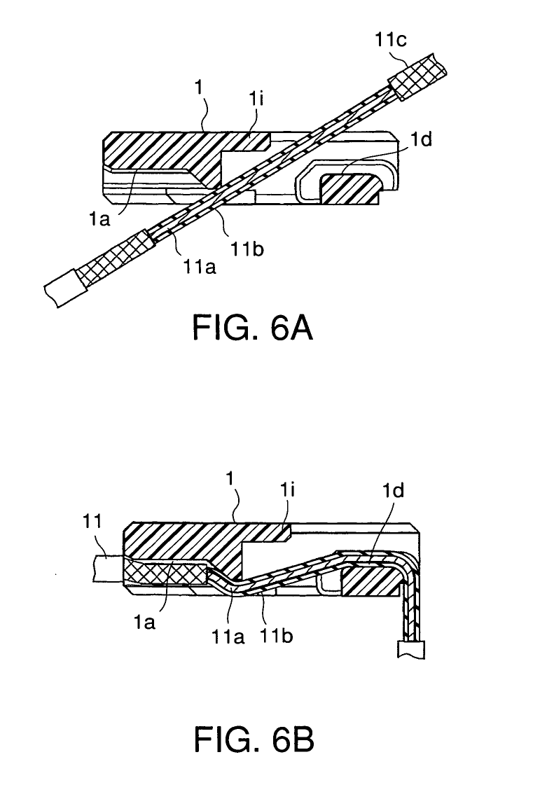

Referring to FIGS. 6A, 6B, 7A, 7B, and 8, description will be made of an Insulation displacement connector according to a third embodiment of the present invention. Similar parts are designated by like reference numerals and description thereof will be omitted.

In the Insulation displacement connector, the first housing 1 has a protruding support portion 1i which protrudes relatively high. Each contact 7 is provided with a disengagement-prevention protruding portion 7d3 formed on a side opposite to the first blade shape portion 7d1 of the insulation displacement terminal portion 7d.

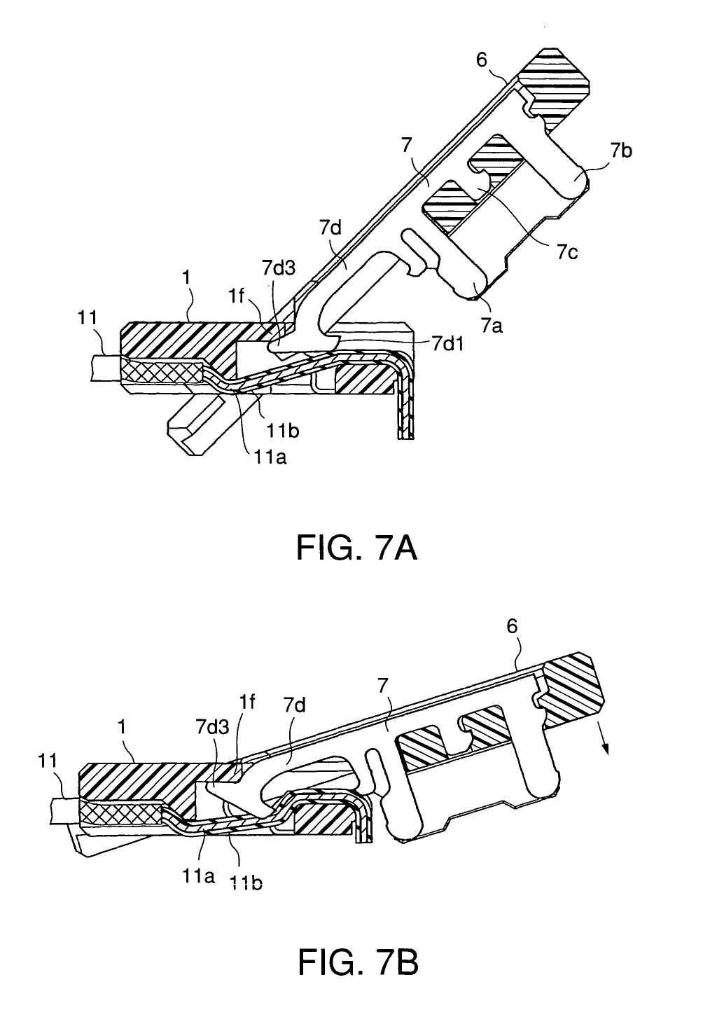

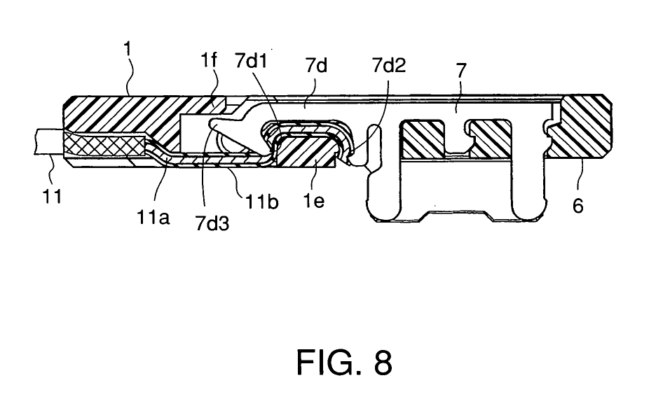

The second housing 6 is inserted into the first housing 1 in an inclined position as illustrated in FIG. 7A and rotated with respect to the first housing 1 to the state illustrated in FIG. 8. Then, the first and the second blade shape portions 7d1 and 7d2 of each contact 7 break the dielectric member 11b of each coaxial cable 11 to be press-contacted with the core wire 11a. As a result, the first and the second blade shape portions 7d1 and 7d2 clamp both of the protruding guide portion 1e of the first housing 1 and the coaxial cable 11. Thus, each contact 7 is electrically connected to each coaxial cable 11. When the second housing 6 is rotated, the disengagement-prevention protruding portion 7d3 is butted against the protruding support portion 1f and is prevented from being disengaged from the protruding support portion 1f.

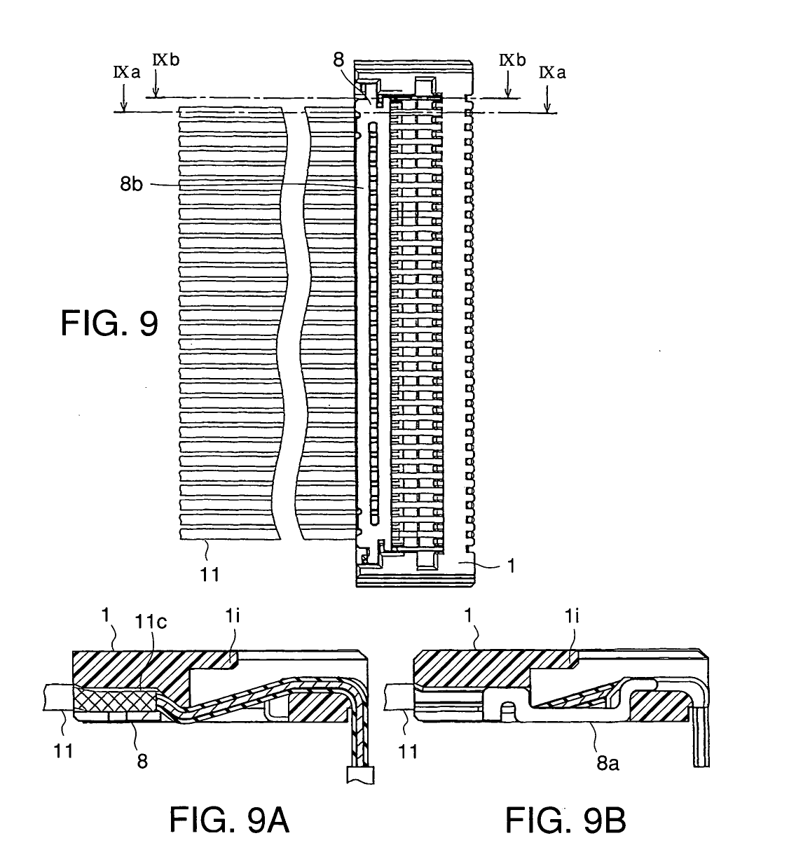

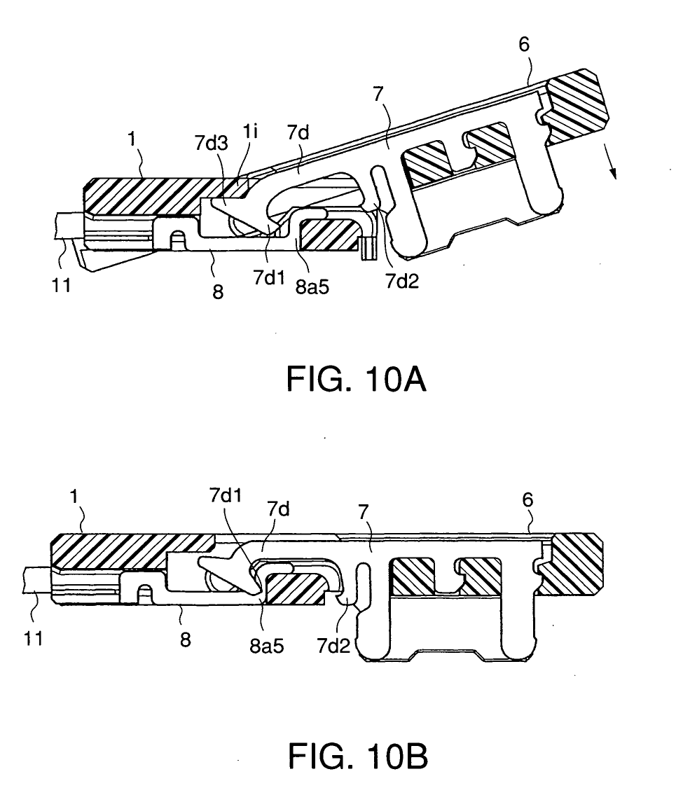

Referring to FIGS. 9, 9A, 9B, 10A, and 10B, description will be made of an Insulation displacement connector according to a fourth embodiment of the present invention. Similar parts are designated by like reference numerals and description thereof will be omitted.

In the Insulation displacement connector, the first housing 1 has the protruding support portion 1i and the contact 7 has the disengagement-prevention protruding portion 7d3.

The second housing 6 is inserted into the first housing 1 in an inclined portion as illustrated in FIG. 10A and rotated with respect to the first housing 1 to the state illustrated in FIG. 10B. Then, the first blade shape portions 7d1 of the contacts 7 arranged at opposite ends in the predetermined direction bite into the L-shaped portion 8a5 of the ground bar 8. Thus, a ground structure is formed.

In each of the remaining contacts 7, the first and the second blade shape portions 7d1 and 7d2 break the dielectric member 11b of each coaxial cable 11 to be press-contacted with the core wire 11a, as illustrated in FIG. 2B. As a result, the blade shape portions 7d1 and 7d2 clamp both of the protruding guide portion 1e of the first housing 1 and the coaxial cable 11. Thus, each contact 7 is electrically connected to each coaxial cable 11. When the second housing 6 is rotated, the disengagement-prevention protruding portion 7d3 is butted against the protruding support portion 1f and is more reliably prevented from being disengaged from the protruding support portion 1f.

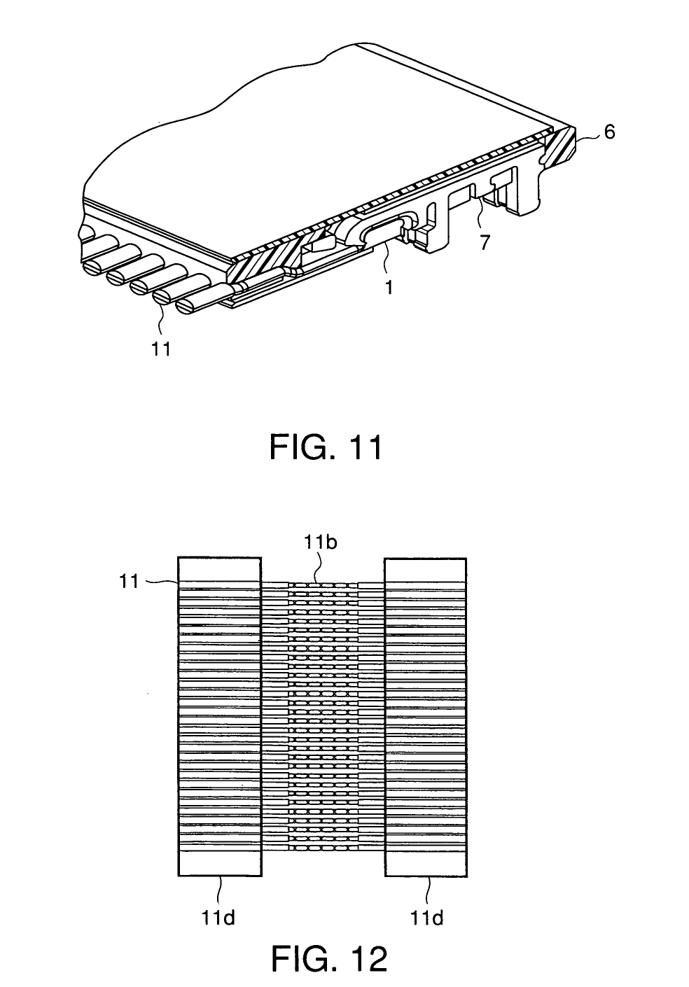

In each of the Insulation displacement connectors of the above-mentioned four types, when the coaxial cables 11 are connected, the state illustrated in FIG. 11 is generally attained. As the coaxial cables 11, use may be made of a flat cable as illustrated in FIG. 12. In the flat cable illustrated in the figure, the coaxial cables 11 are arranged on a single plane with opposite ends fixed by film-like sheets 11d to leave the dielectric member 11b at the center in an exposed state.

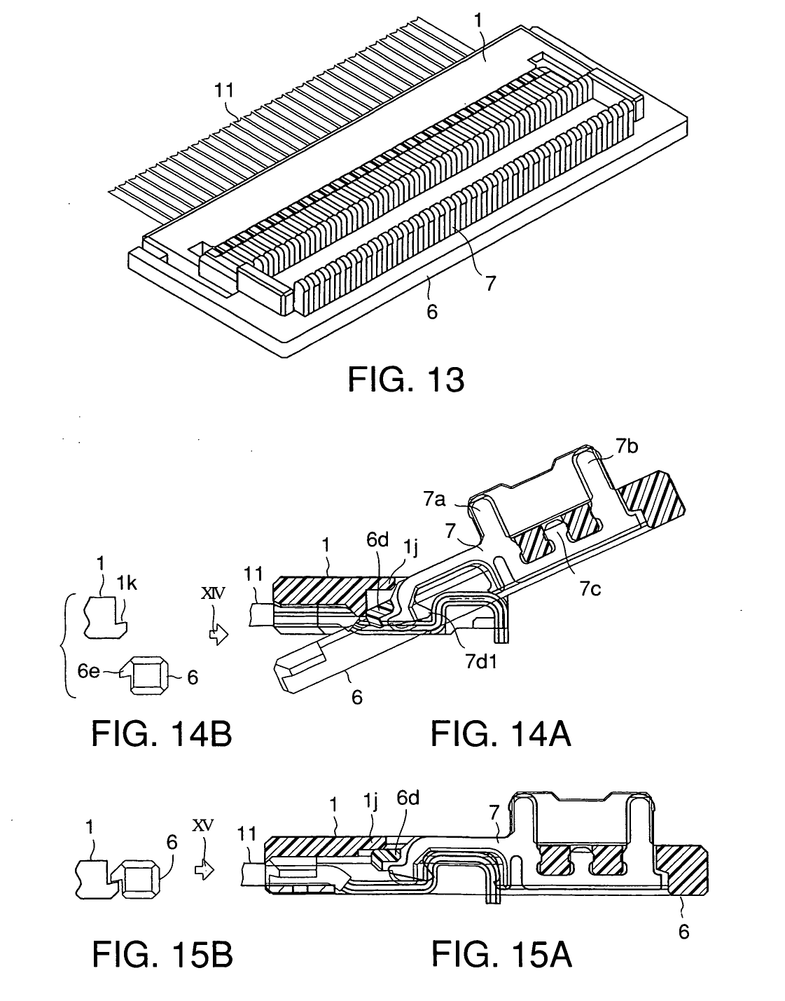

Referring to FIGS. 13, 14A, 14B, 15A, and 15B, description will be made of an Insulation displacement connector according to a fifth embodiment of the present invention. Similar parts are designated by like reference numerals and description thereof will be omitted.

In the Insulation displacement connector, the connection terminal portions 7a and 7b and the fixing portion 7c of each contact 7 are oriented in a direction reverse to that in the foregoing embodiments. In addition, the first blade shape portion 7d1 also serves as the center of rotation or the pivot point. The second housing 6 is provided with a stopped portion 6d while the first housing 1 is provided with the protruding support portion 1i for locking the stopped portion 6d. Further, the first housing 1 is provided with a locking portion 1k while the second housing 6 is provided with a locked portion 6e.

In each of the insulation displacement connectors described above, each contact 7 is produced from a metal thin plate. Each of the grooves 1a, 1d, 1g, and 1h of the first housing may be formed into an appropriate shape, such as a V shape or a U shape.

While the present invention has thus far been described in conjunction with the preferred embodiments thereof, it will be readily possible for those skilled in the art to put this invention into practice in various other manners without departing from the scope of this invention.

1. A connector to be connected to a cable by an insulation displacement connection, comprising:
a first housing having a holding portion for receiving the cable;
a contact to be contacted with a mating connector; and
a second housing holding the contact and coupled to the first housing with its rotation with respect to the first housing,
the contact having a pair of insulation displacement portions faced to each other with a gap and adapted to be connected to the cable by the insulation displacement connection,
the holding portion being inserted into the gap following the rotation of the second housing so that the cable is clamped between each of the insulation displacement portions and the holding portion.

2. The connector according to claim 1, wherein the second housing has a pivot point portion, the first housing having a support portion supporting the pivot point portion.

3. The connector according to claim 2, wherein the insulation displacement contact portions comprise a first blade shape portion and a second blade shape portion farther from the pivot point portion than the first blade shape portion, the holding portion having a recessed portion faced to the second blade shape portion, a part of the cable being bent towards the recessed portion.

4. The connector according to claim 1, wherein the contact has a pivot point portion, the first housing having a support portion supporting the pivot point portion.

5. The connector according to claim 4, wherein the insulation displacement contact portions comprise a first blade shape portion and a second blade shape portion farther from the pivot point portion than the first blade shape portion, the holding portion having a recessed portion faced to the second blade shape portion, a part of the cable being bent towards the recessed portion.

6. The connector according to claim 1, wherein each of the insulation displacement contact portions is a blade shape portion.

7. The connector according to claim 1, wherein the holding portion has a groove for receiving the cable.

8. The connector according to claim 1, wherein the cable is a coaxial cable, the contact being a signal contact to be connected to a core wire of the coaxial cable.

9. The connector according to claim 8, further comprising a ground bar held by the first housing to be connected to an external conductor of the coaxial cable, and a ground contact held by the second housing to be connected to the ground bar.

10. The connector according to claim 1, wherein the cable is a coaxial cable having a core wire and an external conductor insulated from the core wire, the insulation displacement portions being connected to the core wire to use the contact as a signal contact, the connector further comprising:
a ground bar held by the first housing to be connected to the external conductor; and
a ground contact held by the second housing to be connected to the ground bar following the rotation of the second housing.
